(19) United States
(12) Patent Application Publication
(10) Pub. No.: US 2019/0179444 A1
(43) Pub. Date: Jun. 13, 2019

(54) TOUCH PANEL AND TOUCH DEVICE

(71) Applicant: Wuhan China Star Optoelectronics Semiconductor Display Technology Co., Ltd., Wuhan (CN)

(72) Inventor: Jian YE, Shenzhen (CN)

(21) Appl. No.: 15/952,077

(22) Filed: Apr. 12, 2018

Related U.S. Application Data
(63) Continuation of application No. PCT/CN2018/072699, filed on Jan. 15, 2018.

(30) Foreign Application Priority Data
Dec. 12, 2017 (CN) 201711343242.0

(51) Int. Cl. G06F 3/044; G06F 3/041

(52) U.S. Cl. CPC G06F 3/044; G06F 3/0416

(57) ABSTRACT

The present disclosure provides a touch panel and a touch device. The panel includes: a substrate; a plurality of first electrode chains, the plurality of the first electrode chains arranged at intervals, each of the first electrode chains comprising a plurality of first electrodes; a plurality of second electrode chains, each of the second electrode chains comprising a plurality of second electrodes, wherein the second and the first electrode chain are insulated from each other and a gap region is provided between the second electrode chain and the first electrode chain, and a connecting portion is formed at the intersection of the second electrode chain and the first electrode chain; and a plurality of floating electrodes, wherein the floating electrode is electrically insulated from the first electrode chain and the second electrode chain, respectively, for adjusting a mutual capacitance between the second electrode chain and the first electrode chain.

### RELATED APPLICATIONS

This application is a continuation application of PCT Patent Application No. PCT/CN2018/072699, filed Jan. 15, 2018, which claims the priority benefit of Chinese Patent Application No. CN 201711343242.0, filed Dec. 12, 2017, which is herein incorporated by reference in its entirety.

### FIELD OF THE DISCLOSURE

The present disclosure relates to a display technology field, and more particularly to a touch panel and a touch device.

### BACKGROUND OF THE DISCLOSURE

Touch panel according to the working principle can be divided into two kinds of resistance and capacitance, the current capacitive touch panel applications in electronic products increasingly popular. Capacitive touch panel is the use of human body (finger) current sensing work, is a combination of electrodes and the human body to sense the touch signal touch panel. When a person touches the panel, a coupling capacitance is formed between the finger and the conductive layer of the touch panel due to the electric field of the human body. The current generated by the electrodes on the touch panel flows to the contacts, so that the position of the touch point can be accurately calculated. However, the structure of the existing touch panel is relatively simple, and the capacitance value is fixed. The capacitance of the touch panel is not compatible with the capacitance value of the touch driver chip in the market, which hinders the application of this type of touch panel.

### SUMMARY OF THE DISCLOSURE

The present disclosure provides a touch panel, including:

a substrate;
a plurality of first electrode chains disposed on the substrate, the plurality of the first electrode chains arranged at intervals, each of the first electrode chains including a plurality of first electrodes;
a plurality of second electrode chains disposed on the substrate, each of the second electrode chains including a plurality of second electrodes, wherein the second electrode chain and the first electrode chain are insulated from each other and a gap region is provided between the second electrode chain and the first electrode chain, and a connecting portion is formed at the intersection of the second electrode chain and the first electrode chain; and
a plurality of floating electrodes disposed in the gap region, wherein the floating electrode is electrically insulated from the first electrode chain and the second electrode chain, respectively, for adjusting a mutual capacitance between the second electrode chain and the first electrode chain.

Compared with the prior art, the touch panel of the present disclosure adjusts a mutual capacitance between the second electrode chain and the first electrode chain by providing the floating electrode in the gap region between the second electrode chain and the first electrode chain. The floating electrode is electrically insulated from the first electrode chain and the second electrode chain, respectively, for adjusting the mutual capacitance between the second electrode chain and the first electrode chain. Therefore, the mutual capacitance between the second electrode chain and the first electrode chain in the touch panel of the present disclosure is adjustable and is compatible with the touch driving chip in the market.

The present disclosure also provides a touch device. The touch device includes the touch panel as described above.

### BRIEF DESCRIPTION OF THE DRAWINGS

To describe the structural features and effectiveness of the present disclosure more clearly, the following detailed description is accompanied with the accompanying drawings and specific embodiments. Apparently, the accompanying drawings in the following description show merely some embodiments of the present disclosure, and persons of ordinary skill in the art may still derive other drawings from these accompanying drawings without creative efforts.

FIG. 1 is a schematic structural diagram of the touch panel provided by Embodiment 1 of the present disclosure.

FIG. 2 is a schematic diagram of a bridge structure of the touch panel according to Embodiment 1 of the present disclosure.

FIG. 3 (a) to FIG. 3 (c) are schematic diagrams of the structure of the connecting portion of the touch panel according to Embodiment 1 of the present disclosure.

FIG. 4 to FIG. 8 are schematic structural diagrams of the floating electrode according to a preferred embodiment of the present disclosure.

FIG. 9 to FIG. 13 are schematic structural diagrams of the touch panel provided in Embodiment 2 of the present disclosure.

FIG. 14 is a schematic structural diagram of the touch device according to the embodiment of the present disclosure.

### DETAILED DESCRIPTION OF PREFERRED EMBODIMENTS

The technical solutions in the embodiments of the present disclosure are clearly and completely described below with reference to the accompanying drawings in the embodiments of the present disclosure. Obviously, the described embodiments are only a part but not all of the embodiments of the present disclosure. All other embodiments obtained by a person of ordinary skill in the art based on the embodiments of the present disclosure without creative efforts shall fall within the protection scope of the present disclosure.

Reference herein to “an embodiment” means that a particular feature, structure, or characteristic described in connection with the embodiment may be included in at least one embodiment of the disclosure. The appearances of the phrase in various places in the specification are not necessarily all referring to the same embodiment, nor are separate or alternative embodiments mutually exclusive of other embodiments. Those skilled in the art understand that the embodiments described herein may be combined with other embodiments.

In order to make the technical solutions provided by the embodiments of the present disclosure clearer, the foregoing solutions are described in detail below with reference to the accompanying drawings.

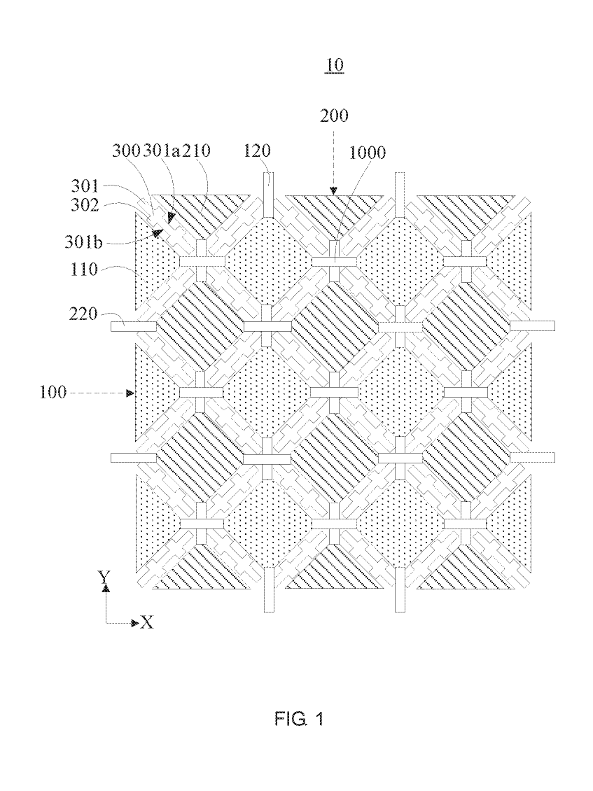

Referring to FIG. 1, FIG. 1 is a schematic structural diagram of the touch panel provided by Embodiment 1 of the present disclosure. The touch panel 10 includes a substrate (not shown); a plurality of first electrode chains 100 disposed on the substrate, the plurality of first electrode chains 100 spaced apart from each other, each of the first electrode chains 100 including a plurality of first electrodes 110;

a plurality of second electrode chains 200 disposed on the substrate, each of the second electrode chains 200 including a plurality of second electrodes 210, wherein the second electrode chain 200 is insulated from the first electrode chain 100 and has a gap region between the second electrode chain 200 and the first electrode chain 100, and a connecting portion 1000 formed at the intersection of the second electrode chain 200 and the first electrode chain 100; and
a plurality of floating electrodes 300 disposed in the gap region are respectively electrically insulated from the first electrode chain 100 and the second electrode chain 200 for adjusting the mutual capacitance between the second electrode chain 200 and the first electrode chain 100.

The substrate is a transparent substrate, such as a glass substrate, a plastic substrate, or the like, and may be a flexible substrate.

Each floating electrode 300 includes a bar 301 parallel to the gap region and a plurality of protrusions 302 disposed on the bar 301. The bar 301 includes a first surface 301a and a second surface 301b disposed oppositely. The protrusion 302 is disposed on at least one surface of the first surface 301a and the second surface 301b and is spaced apart from each other.

The connecting portion 1000 includes a first connecting portion 220 and a second connecting portion 120, the first connecting portion 220 and the second connecting portion 120 are alternately and electrically insulated, the first connecting portion 220 is for connecting two adjacent first electrodes 110, and the second connecting portion 120 is for connecting two adjacent second electrodes 210.

Preferably, the first electrode 110 is a sensing electrode, and the second electrode 210 is a driving electrode. Or the first electrode 110 is a driving electrode and the second electrode 210 is a sensing electrode.

Each of the first electrode chains 100 includes a plurality of first electrodes 110 spaced apart from each other, and two adjacent first electrodes 110 are electrically connected by the first connecting portion 220. Preferably, on the same first electrode chain 100: the two adjacent first electrodes 110 may also be directly point-to-point connected. In this embodiment, the first connecting portion 220 is formed integrally with the first electrode chain 100 and patterned in a photomask during the manufacturing process. However, the width of the first connecting portion 220 is smaller than that of the first electrode chain 100.

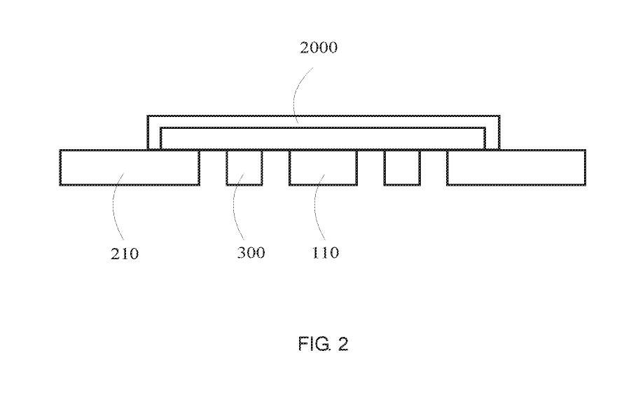

Each of the second electrode chains 200 includes a plurality of second electrodes 210 spaced apart and two adjacent second electrodes 210 electrically connected through the second connecting portion 120. Preferably, on the same second electrode chain 200: two adjacent second electrodes 210 may be connected by a bridge 2000, as shown in FIG. 2. Or may be electrically connected through other structures, which is not limited in the present application.

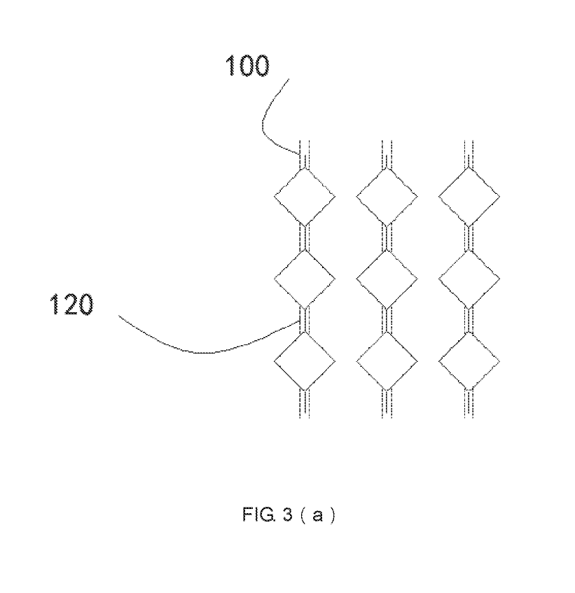

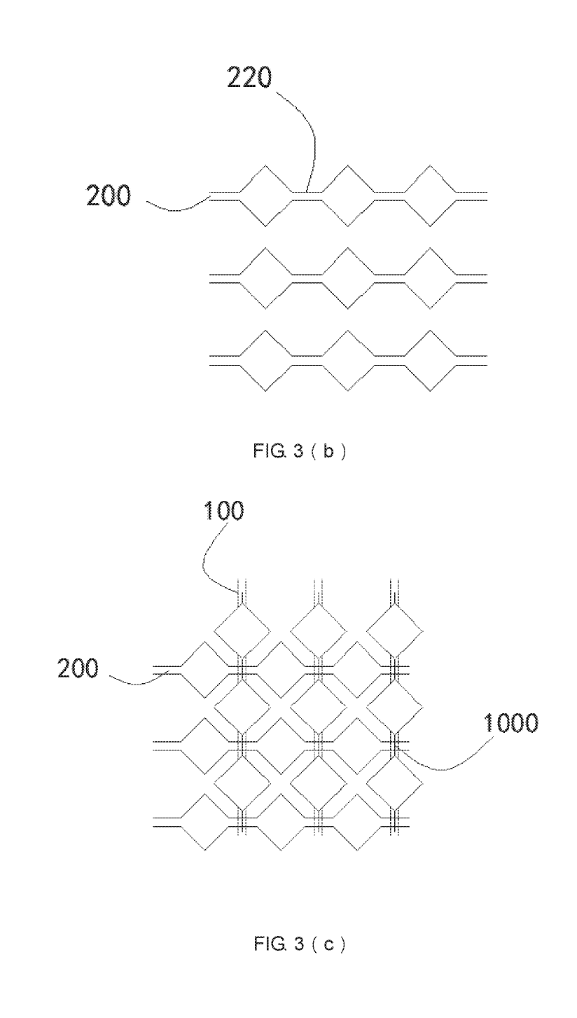

A plurality of second electrode chains 200 are disposed on the substrate. The second electrode chain 200 and the first electrode chain 100 are alternately insulated. A connecting portion 1000 are formed at the intersection of the second electrode chain 200 and the first electrode chain 100. The connecting portion 1000 includes a first connecting portion 220 and a second connecting portion 120. The first connecting portion 220 and the second connecting portion 120 are alternately and electrically insulated. The first connecting portion 220 is for connecting two adjacent first electrodes 110, the second connecting portion 120 is for connecting the two adjacent second electrodes 210. See FIG. 3 (a), FIG. 3 (b) and FIG. 3 (c).

The floating electrode 300 is electrically insulated from the first electrode chain 100 and the second electrode chain 200. There is a gap between the floating electrode 300 and the first electrode chain 100 and the second electrode chain 200. The gap between the floating electrode 300 and the first electrode chain 100 and the second electrode chain 200 may also be filled with an insulating material, which is not limited herein.

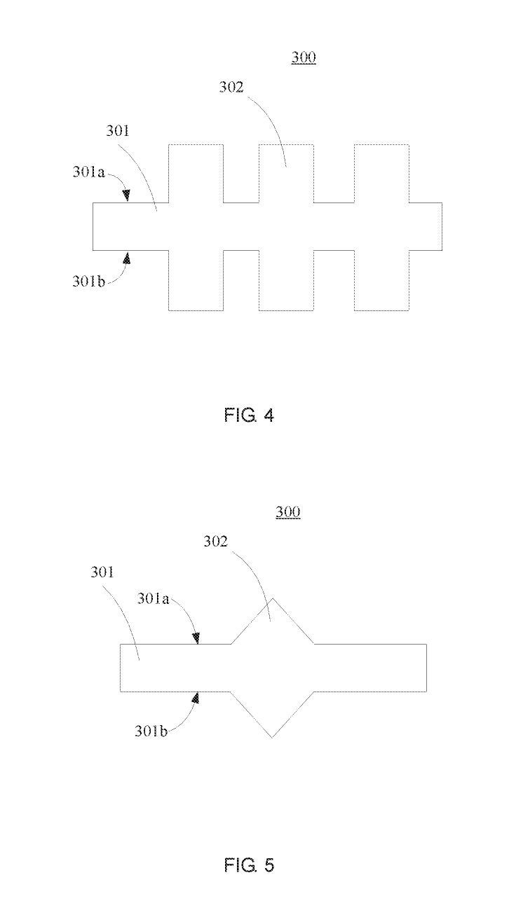

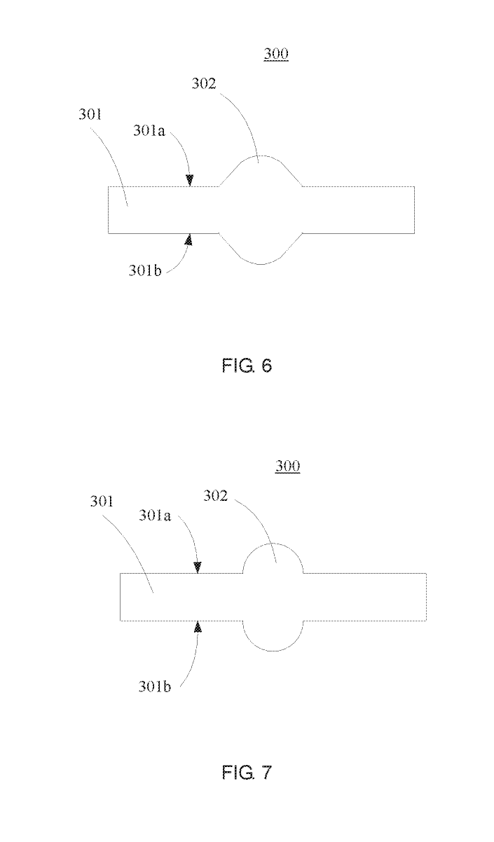

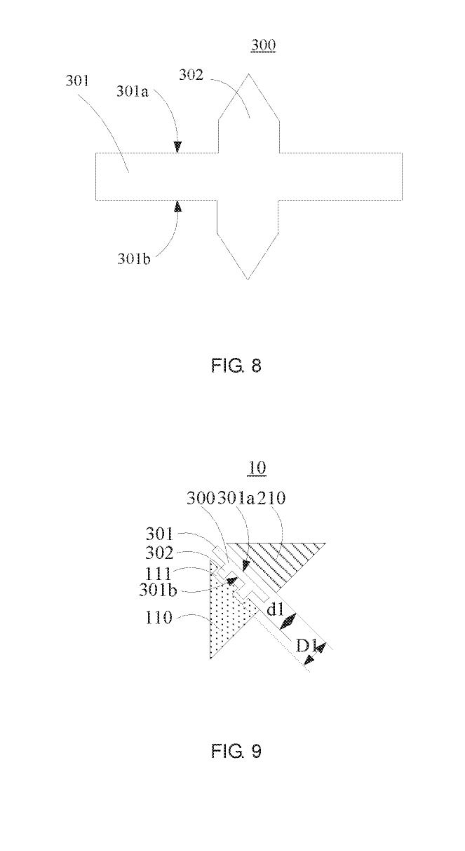

Please refer to FIG. 4 to FIG. 8 together. FIG. 4 to FIG. 8 show the structure of the floating electrode according to a preferred embodiment of the present disclosure.

The floating electrode 300 includes a bar 301 and a plurality of protrusions 302. The bar 301 includes a first surface 301a and a second surface 301b disposed oppositely. The protrusion 302 is disposed on at least one surface of the first surface 301a and the second surface 301b, and is spaced apart from each other. Optionally, the number of the bars 301 may be one or more, and the number of the bars 301 is not limited herein. The outline of the protrusion 302 may be rectangular, diamond, triangle, arc or wavy, or may be a combination of the above structures, or may be other irregular structures, in this application, the outline of the protrusion 302 is not limited. Optionally, the protrusions 302 may be disposed only on the first surface 301a or only on the second surface 301b, and may also be disposed on the first surface 301a and the second surface 301b at the same time, in this application, the installation surface of the protrusion 302 is not limited. In addition, the number of the protrusions 302 may be one, or may be multiple, as long as it does not violate the improvement of the present application, are considered to be eligible.

In an embodiment, the first electrode chain 100, the second electrode chain 200 and the floating electrode 300 are disposed on the same layer and are made of the same material. As formed by the same transparent conductive material or metal material layer, so that it can be simultaneously formed by one patterning process, thereby simplifying the process. In another embodiment, one of the first electrode chain 100 and the second electrode chain 200 is disposed in the same layer as the floating electrode 300 and is made of the same material, the first electrode chain 100 and the second electrode chain 200 are disposed in different layers. One of the first electrode chains 100 and the second electrode chains 200 and the floating electrode 300 are disposed on the first layer on the substrate, and may be made of the same material while the other one of the first electrode chains 100 and the second electrode chains 200 is disposed on a second layer different from the first layer so that formation of the bridge 2000 connection structure described above may be avoided.

The first electrode 110 and/or the second electrode 210 is a block structure made of a transparent conductive material. The entire touch layer composed of the first electrode chain 100 and the second electrode chain 200 is a network structure. And may be formed in various shapes, such as a diamond shape, a square shape, a rectangular shape, etc., which is not limited in the present disclosure. In a preferred embodiment, in the case where the first electrode 110 and the second electrode 210 have a diamond shape or a square shape, the adjacent first electrodes 110 in each of the first electrode chains 100 are electrically connected to each other in the first direction at the apexes of a rhombus shape or a square shape, the adjacent second electrodes 210 in each of the second electrode chains 200 are electrically connected to each other by the above-described bridge 2000 structure at the apexes of a diamond shape or a square shape in the second direction.

In the touch panel 10 provided in the embodiment of the present disclosure, the floating electrode 300 is disposed in the gap region between the second electrode chain 200 and the first electrode chain 100, each second electrode chain 200 includes a plurality of second electrodes 210, each first electrode chain 100 includes a plurality of first electrodes 110. The second electrode chain 200 is electrically insulated from the first electrode chain 100, the floating electrode 300 is electrically insulated from the second electrode chain 200 and the first electrode chain 100, respectively. The floating electrode 300 includes a bar 301 and a plurality of protrusions 302. The bar 301 includes a first surface 301a and a second surface 301b disposed oppositely. The protrusion 302 is disposed on at least one surface of the first surface 301a and the second surface 301b, and is spaced apart from each other.

The touch panel provided by the technical solution includes a floating electrode 300, the floating electrode 300 includes a bar 301 and a plurality of protrusions 302. The floating electrode 300 having the protrusion 302 has a large volume, a large dielectric capacity, and a large dielectric constant. The floating electrode 300 without the protrusion 302 has a small volume, a small dielectric capacity, and a small dielectric constant. The structure of such a floating electrode can be set by changing the mutual capacitance between the second electrode 210 and the first electrode 110 corresponding to the position of the protrusion 302 so as to achieve mutual capacitance adjustment between the second electrode chain 200 and the first electrode chain 100. By mutual compensation between the capacitance values, the mutual capacitance adjustment between the second electrode chain 200 and the first electrode chain 100 is realized, which is easy to be compatible with the touch control driver chip in the market.

Referring to FIG. 9, FIG. 9 is a schematic structural diagram of a touch panel provided in a second embodiment of the present disclosure. The touch panel provided in the second embodiment of the present disclosure has the same basic structure as the touch panel provided in the first embodiment, the same components in the touch panel provided in the second embodiment have the same functions as those in the touch panel provided in the first embodiment. The difference is that the first electrode 110 and/or the second electrode 210 of the touch panel provided in the second embodiment includes a plurality of spaced-apart grooves. The groove is disposed at an edge of the first electrode 110 and/or the second electrode 210 close to the gap region, and the protrusion 302 is disposed in the receiving space of the groove without contact with the edge of the first electrode 110 and/or the second electrode 210. The width of the protrusion 302 is greater than the width of the bar 301, the first capacitance between the first electrode 110 and the second electrode 210 corresponding to the position of the protrusion 302 is smaller than the second capacitance between the first electrode 110 and the second electrode 210 corresponding to the position of the bar 301. Through the mutual compensation between the first capacitor and the second capacitor, the adjustment of the capacitance between the first electrode 110 and the second electrode 210 is realized, so as to realize the mutual capacitance adjustment between the second electrode chain 200 and the first electrode chain 100. By mutual compensation between the capacitance values, the mutual capacitance adjustment between the second electrode chain 200 and the first electrode chain 100 is realized, which is easy to be compatible with the touch control driver chip in the market.

The protrusion 302 is optional disposed in the receiving space of the recess, and the protrusion 302 may also be disposed at a position facing the receiving space of the recess. In addition, the protrusion 302 may also be disposed at a position offset from the receiving space of the groove. The grooves may be provided only at the edge of the first electrode 110, at the edge of the second electrode 210, or at the edge of the first electrode 110 and the second electrode 210 at the same time. Optionally, the number of grooves may be one or more. This application does not limit the above optional solutions, so long as they do not violate the original intention of the application, they are considered to be eligible.

For example, when the groove 111 is disposed at the edge of the first electrode 110, referring to FIG. 9, the groove 111 is disposed on the edge of the first electrode 110. The protrusion 302 of the floating electrode 300 is disposed in the receiving space of the groove 111. At this time, the distance between the bottom of the groove 111 and the end face of the second electrode 210 adjacent to the bar 301 is D1, D1 can be regarded as a fixed value. The distance between the end surface of the protrusion 302 adjacent to the first electrode 110 and the end surface of the second electrode 210 adjacent to the bar 301 is d1, d1 can be changed. Since D1 is greater than d1, the capacitance between the first electrode 110 and the second electrode 210 is small at the portion of the distance D1. At the distance d1, the capacitance between the first electrode 110 and the second electrode 210 is larger. By increasing or decreasing d1, the ratio between the distance D1 and the distance d1 is adjusted and matched with each other to compensate each other. Since the protrusions 302 are arranged at intervals, a portion with a large capacitance value and a portion with a small capacitance value may form a mutual compensation effect. It is conducive to adjusting the mutual capacitance between the first electrode 110 and the second electrode 210 so as to realize the mutual capacitance adjustment between the second electrode chain 200 and the first electrode chain 100. By mutual compensation between the capacitance values, the mutual capacitance adjustment between the second electrode chain 200 and the first electrode chain 100 is realized, which is easy to be compatible with the touch control driver chip in the market.

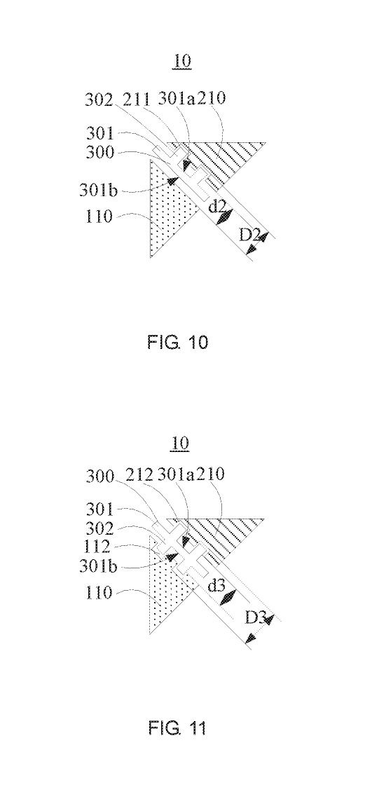

Referring to FIG. 10, FIG. 10 is another schematic structural diagram of a touch panel provided in Embodiment 2 of the present disclosure. The groove 211 is disposed on the edge of the second electrode 210. The protrusion 302 of the floating electrode 300 is disposed in the receiving space of the groove 211. At this time, the maximum distance between the groove 211 and the first electrode 110 is D2, D2 can be regarded as a fixed value, the minimum distance between the second electrode 210 and the edge portion of the first electrode 110 is d2, d2 can be changed. Since D2 is greater than d2, the capacitance between the first electrode 110 and the second electrode 210 is small at the portion of the distance D2. In the region of the distance d2, the capacitance between the first electrode 110 and the second electrode 210 is relatively large. By increasing or decreasing d2, it is used to adjust the ratio of the maximum distance D2 to the minimum distance d2 so as to match each other and compensate each other.

The protrusion 302 is disposed in the receiving space of the groove is optional, not necessarily to do so. Further, the protrusion 302 may also be disposed at a position facing the receiving space of the recess, not necessarily disposed in the receiving space of the recess. In addition, the protrusion 302 may also be disposed at a position offset from the receiving space of the groove. Optionally, the grooves may be disposed only on the edge of the second electrode 210, the edge of the first electrode 110, or the edge of the first electrode 110 and the second electrode 210. Optionally, the number of grooves may be one or more. This application does not limit the above optional solutions, so long as they do not violate the original intention of the application, they are considered to be eligible.

Referring to FIG. 11, FIG. 11 is still another schematic structural diagram of a touch panel provided in Embodiment 2 of the present disclosure. The first groove 112 is disposed on the edge of the first electrode 110, the second groove 212 is disposed on the edge of the second electrode 210. The protrusion 302 of the floating electrode 300 is disposed in the receiving space of the first groove 112 and the second groove 212. At this time, the maximum distance between the first groove 112 and the second groove 212 is D3, and the minimum distance between the second electrode 210 and the edge portion of the first electrode 110 is d3. Since D3 is greater than d3, the capacitance between the first electrode 110 and the second electrode 210 is small at the distance D3, and the capacitance between the first electrode 110 and the second electrode 210 is larger at the distance d3. By increasing or decreasing the maximum distance D3 and the minimum distance d3, the ratio for adjusting the maximum distance D3 and the minimum distance d3 is matched with each other to compensate each other. Since the protrusions 302 are arranged at intervals, a portion with a large capacitance value and a portion with a small capacitance value may form a mutual compensation effect, which helps to adjust the mutual capacitance between the first electrode 110 and the second electrode 210 and further realize the mutual capacitance adjustment between the second electrode chain 200 and the first electrode chain 100. By mutual compensation between the capacitance values, the mutual capacitance adjustment between the second electrode chain 200 and the first electrode chain 100 is realized, which is easy to be compatible with the touch control driver chip in the market.

The protrusion 302 disposed in the receiving space of the first groove 112 and the second groove 212 is optional, and it is not necessary to do so. Further, the protrusion 302 may also be disposed at a position facing the receiving space of the first groove 112 or the second groove 212 and not necessarily disposed in the receiving space of the first groove 112 or the second groove 212. In addition, the protrusion 302 may also be disposed at a receiving space position that is offset from the first groove 112 or the second groove 212. Optionally, the first groove 112 or the second groove 212 may be disposed at the edge of the second electrode 210 only or at the edge of the first electrode 110 only or at the edge of the first electrode 110 and the second electrode 210 at the same time. Optionally, the number of grooves may be one or more. This application does not limit the above optional solutions, so long as they do not violate the original intention of the application, they are considered to be eligible.

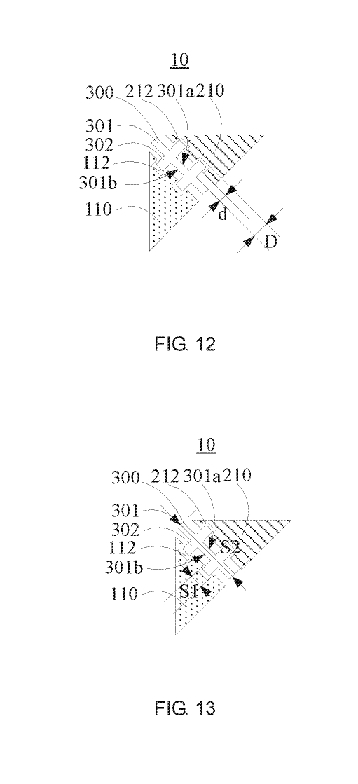

Referring to FIG. 12, FIG. 12 is another schematic structural diagram of a touch panel provided in Embodiment 2 of the present disclosure. The minimum distance between the protrusion 302 and the groove on the first electrode 110 or the second electrode 210 is marked as a first distance D, which is variable. The minimum distance between the bar 301 without the protrusion 302 and the first electrode or the second electrode is marked as the second distance d, which can be regarded as a fixed value. By increasing or decreasing the first distance D for adjusting the ratio of the first distance D and the second distance d to match each other and compensate each other. By mutual compensation between the first distance D and the second distance d, the adjustment of the capacitance between the first electrode 110 and the second electrode 210 is achieved.

Further, since the first distance D is greater than the second distance d, the capacitance between the first electrode 110 and the second electrode 210 corresponding to the first distance D is smaller than the capacitance between the first electrode 110 and the second electrode 210 corresponding to the second distance d. The protrusions 302 are spaced apart, the first distance D is variable, the second distance d can be regarded as a fixed value. By increasing or decreasing the first distance D for adjusting the ratio of the first distance D and the second distance d to match each other and compensate each other. Since the capacitances formed between the first distance D and the second distance d adjacent to each other can have a mutual compensation effect so as to achieve the purpose of adjusting the mutual capacitance between the first electrode 110 and the second electrode 210 so as to realize mutual capacitance adjustment between the second electrode chain 200 and the first electrode chain 100. By mutual compensation between the capacitance values, the mutual capacitance adjustment between the second electrode chain 200 and the first electrode chain 100 is realized, which is easy to be compatible with the touch control driver chip in the market.

Referring to FIG. 13, FIG. 13 is still another schematic structural diagram of a touch panel provided in Embodiment 2 of the present disclosure. The facing area between the protrusion 302 and the first electrode 110 and the second electrode 210 is referred to as a first facing area S1. The facing area between the bar 301, the first electrode 110 and the second electrode 210 is referred to as a second facing area S2. The floating electrode 300 is cut open, where S1 is the cross-sectional area of the protrusion 302, S2 is the cross-sectional area of the bar 301, the first facing area S1 can be changed, the second facing area S2 can be regarded as a fixed value. By increasing or decreasing the first facing area S1, the ratio of the first facing area S1 and the second facing area S2 is adjusted and matched with each other to compensate each other. The mutual compensation between the first facing area S1 and the second facing area S2 can realize the adjustment of the capacitance between the first electrode 110 and the second electrode 210.

Further, since the first facing area S1 and the second facing area S2 may be different, therefore, the capacitance values between the first electrode 110 and the second electrode 210 corresponding to the first facing area S1 are also different from the capacitance values between the first electrode 110 and the second electrode 210 corresponding to the second facing area S2 while the protrusions 302 are arranged at intervals. The floating electrode 300 is cut open, where S1 is the cross-sectional area of the protrusion 302, S2 is the cross-sectional area of the bar 301. The first positive area S1 can be varied, the second positive area S2 can be regarded as a fixed value. By increasing or decreasing the first facing area S1, the ratio of the first facing area S1 and the second facing area S2 is adjusted and matched with each other to compensate each other.

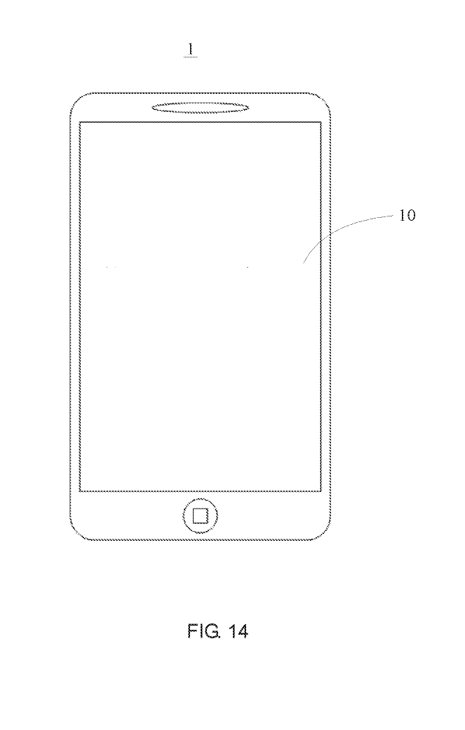

Referring to FIG. 14, FIG. 14 is a schematic structural diagram of a touch device according to an embodiment of the present disclosure. The touch device 1 includes a touch panel 10. The touch panel 10 may be the touch panel 10 provided in any one of the foregoing embodiments, and details are not described herein again. The touch device 1 may be, but not limited to, an electronic book, a smart phone (such as an Android mobile phone, an iOS mobile phone, a Windows Phone mobile phone, etc.), a tablet, a palmtop computer, a laptop, a mobile Internet device (MID) or a wearable device.

The embodiments of the present disclosure are described in detail above. Specific examples are used herein to describe the principles and implementation manners of the present disclosure. The description of the foregoing embodiments is merely used to help understand the method and core idea of the present disclosure. Meanwhile, those skilled in the art may make modifications to the specific implementation manners and the application scope according to the idea of the present disclosure. To sum up, the contents of the description should not be construed as limiting the present disclosure.

What is claimed is:

1. A touch panel, comprising:
a substrate;
a plurality of first electrode chains disposed on the substrate, the plurality of the first electrode chains arranged at intervals, each of the first electrode chains comprising a plurality of first electrodes;
a plurality of second electrode chains disposed on the substrate, each of the second electrode chains comprising a plurality of second electrodes, wherein the second electrode chain and the first electrode chain are insulated from each other and a gap region is provided between the second electrode chain and the first electrode chain, and a connecting portion is formed at an intersection of the second electrode chain and the first electrode chain; and
a plurality of floating electrodes disposed in the gap region, wherein the floating electrode is electrically insulated from the first electrode chain and the second electrode chain, respectively, and is configured to adjust a mutual capacitance between the second electrode chain and the first electrode chain.

2. The touch panel according to claim 1, wherein the connecting portion comprises a first connecting portion and a second connecting portion, the first connecting portion and the second connecting portion are disposed alternately and insulatively, and the first connecting portion is configured to connect two adjacent first electrodes and the second connecting portion is configured to connect two adjacent second electrodes.

3. The touch panel according to claim 1, wherein each of the floating electrodes comprises a bar parallel to the gap region and a plurality of protrusions disposed on the bar.

4. The touch panel according to claim 3, wherein the bar comprises a first surface and a second surface opposite to each other, and the protrusion is disposed on at least one of the first surface and the second surface and spaced apart from each other.

5. The touch panel according to claim 1, wherein the first electrode and/or the second electrode comprise a plurality of spaced-apart grooves arranged on an edge of the first electrode or the second electrode close to the gap region, and the protrusion is disposed in the groove and the protrusion does not contact the edge of the first electrode and/or the second electrode.

6. The touch panel according to claim 3, wherein a width of the protrusion is greater than a width of the bar, a first capacitance between the first electrode and the second electrode corresponding to a position of the protrusion is smaller than a second capacitance between the first electrode and the second electrode corresponding to a position of the bar, so as to adjust the mutual capacitance between the second electrode chain and the first electrode chain.

7. The touch panel according to claim 1, wherein a minimum distance between the protrusion and the first electrode or the second electrode is marked as a first distance, a minimum distance between the bar and the first electrode or the second electrode is marked as a second distance, the mutual capacitance between the second electrode chain and the first electrode chain is adjusted by adjusting the ratio of the first distance and the second distance.

8. The touch panel according to claim 1, wherein a facing area of the protrusion between the first electrode and the second electrode is referred to as a first facing area, a facing area of the bar between the first electrode and the second electrode is referred to as a second facing area, the mutual capacitance between the second electrode chain and the first electrode chain is adjusted by adjusting the ratio of the first facing area and the second facing area.

9. The touch panel according to claim 1, wherein one of the first electrode chain and the second electrode chain is disposed in the same layer as the floating electrode and is made of the same material, the first electrode chain and the second electrode chain are disposed in different layers.

10. A touch device, comprising a touch panel comprising:
a substrate;
a plurality of first electrode chains disposed on the substrate, the plurality of the first electrode chains arranged at intervals, each of the first electrode chains comprising a plurality of first electrodes;
a plurality of second electrode chains disposed on the substrate, each of the second electrode chains comprising a plurality of second electrodes, wherein the second electrode chain and the first electrode chain are insulated from each other and a gap region is provided between the second electrode chain and the first electrode chain, and a connecting portion is formed at an intersection of the second electrode chain and the first electrode chain; and
a plurality of floating electrodes disposed in the gap region, wherein the floating electrode is electrically insulated from the first electrode chain and the second electrode chain, respectively, and is configured to adjust a mutual capacitance between the second electrode chain and the first electrode chain.

11. The touch device according to claim 10, wherein the connecting portion comprises a first connecting portion and a second connecting portion, the first connecting portion and the second connecting portion are disposed alternately and insulatively, and the first connecting portion is configured to connect two adjacent first electrodes and the second connecting portion is configured to connect two adjacent second electrodes.

12. The touch device according to claim 10, wherein each of the floating electrodes comprises a bar parallel to the gap region and a plurality of protrusions disposed on the bar.

13. The touch device according to claim 12, wherein the bar comprises a first surface and a second surface opposite to each other, and the protrusion is disposed on at least one of the first surface and the second surface and spaced apart from each other.

14. The touch device according to claim 10, wherein the first electrode and/or the second electrode comprise a plurality of spaced-apart grooves arranged on an edge of the first electrode or the second electrode close to the gap region, and the protrusion is disposed in the groove and the protrusion does not contact the edge of the first electrode and/or the second electrode.

15. The touch device according to claim 12, wherein a width of the protrusion is greater than a width of the bar, a first capacitance between the first electrode and the second electrode corresponding to a position of the protrusion is smaller than a second capacitance between the first electrode and the second electrode corresponding to a position of the bar, so as to adjust the mutual capacitance between the second electrode chain and the first electrode chain.

16. The touch device according to claim 10, wherein a minimum distance between the protrusion and the first electrode or the second electrode is marked as a first distance, a minimum distance between the bar and the first electrode or the second electrode is marked as a second distance, the mutual capacitance between the second electrode chain and the first electrode chain is adjusted by adjusting the ratio of the first distance and the second distance.

17. The touch device according to claim 10, wherein a facing area of the protrusion between the first electrode and the second electrode is referred to as a first facing area, a facing area of the bar between the first electrode and the second electrode is referred to as a second facing area, the mutual capacitance between the second electrode chain and the first electrode chain is adjusted by adjusting the ratio of the first facing area and the second facing area.

18. The touch device according to claim 10, wherein one of the first electrode chain and the second electrode chain is disposed in the same layer as the floating electrode and is made of the same material, the first electrode chain and the second electrode chain are disposed in different layers.
